(19) United States
(12) Patent Application Publication
(10) Pub. No.: US 2006/0039411 A1
(43) Pub. Date: Feb. 23, 2006

(54) SONET/SDH frame synchronization in the presence of high bit error rates

(76) Inventors: Suvhasis Mukhopadhyay, Shrewsbury, MA (US); Ramses Valvekens, Herent (BE); Cedric Esqueret, Kluisbergen (BE); Yudhisthira Kundu, New Delhi (IN)

Correspondence Address: GORDON & JACOBSON, P.C., 60 LONG RIDGE ROAD, SUITE 407, STAMFORD, CT, 06902, US

(21) Appl. No.: 10/924,042

(22) Filed: Aug. 23, 2004

(51) Int. Cl. H04J 3/06

(52) U.S. Cl. 370/509

(57) ABSTRACT

A SONET/SDH frame synchronization method uses one framing pattern to find the frame and a second framing pattern to monitor the frame after it is acquired. The first framing pattern uses twenty-four bits selected from the A1 and A2 bytes. After acquisition, the second framing, pattern uses only twelve bits, e.g. the last four bits of the last A1 byte and all of the first A2 byte. The framing pattern comparisons are made with a window of N+1 bytes or 2N bytes. The method of the invention meets the requirements of Telcordia GR-253 and eliminates aliasing in the last H2 bytes. The method can also be applied to enhanced framing in STS-192 and STS-768. An exemplary implementation of the method is realized in a state machine.

### BACKGROUND OF THE INVENTION

1. Field of the Invention

This invention relates broadly to telecommunications. More particularly, this invention relates to the Synchronous Optical Network (SONET)/Synchronous Digital Hierarchy (SDH) and to achieving and maintaining frame synchronization in the presence of a specified bit error rate (BER).

2. State of the Art

The Synchronous Optical Network (SONET) or the Synchronous Digital Hierarchy (SDH), as it is known in Europe, is a common telecommunications transport scheme which is designed to accommodate both DS-1 (T1) and E1 traffic as well as multiples (DS-3 and E-3) thereof.

Developed in the early 1980s, SONET has a base (STS-1) rate of 51.84 Mbit/sec in North America. The STS-1 signal can accommodate 28 DS-1 signals or 21 E1 signals or a combination of both. The basic STS-1 signal has a frame length of 125 microseconds (8,000 frames per second) and is organized as a frame of 810 octets (9 rows by 90 byte-wide columns). It will be appreciated that 8,000 frames*810 octets per frame*8 bits per octet=51.84 Mbit/sec.

In Europe, the base (STM-1) rate is 155.520 Mbit/sec, equivalent to the North American STS-3 rate (3*51.84=155.520). The STS-3 (STM-1) signals can accommodate 3 DS-3 signals or 63 E1 signals or 84 DS-1 signals, or a combination of them. The STS-12 signals are 622.080 Mbps and can accommodate 12 DS-3 signals, etc. The STS-48 signals are 2,488.320 Mbps and can accommodate 48 DS-3 signals, etc. The highest defined STS signal, the STS-768, is nearly 40 Gbps (gigabits per second). The abbreviation STS stands for Synchronous Transport Signal and the abbreviation STM stands for Synchronous Transport Module. STS-n signals are also referred to as Optical Carrier (OC-n) signals when transported optically rather than electrically.

Prior art FIG. 1 illustrates the basic STS-1 frame. The frame includes the synchronous payload envelope (SPE) or virtual container (VC) as it is known in Europe, as well as transport overhead. Transport overhead is contained in the first three columns (27 bytes) and the SPE/VC occupies the remaining 87 columns. The first column of the SPE/VC includes path overhead.

Prior art FIG. 2 illustrates the transport overhead (TOH) and path overhead (POH) bytes. The A1 and A2 bytes indicate the start of a SONET frame. The remainder of the bytes in the first three rows (which are referred to as section overhead) of the TOH are used for various Operations, Administration, Maintenance, and Provisioning tasks. The last six rows of the TOH are referred to a line overhead. These bytes are used for locating the SPE/VC in the frame, multiplexing or concatenating signals, performance monitoring, automatic protection switching, and line maintenance. The H1 and H2 bytes indicate the beginning of the SPE/VC which can begin anywhere in the 87 column by 9 row space allotted to it. Among the TOH bytes are bytes B1 and B2 which are eight-bit interleave parity (BIP-8) codes. Similarly, the path overhead includes byte B3 which is a BIP-8 code byte. The BIP-8 bytes in the transport and path overhead are used to monitor in-service performance. Thus, the number of received BIP-8 code violations can be converted to the bit error rate (BER) of an STS-N type signal. As set forth in Telcordia document GR-253, a user-selected BER threshold ranging from a high BER of 1×10⁻³ to a low BER of 1×10⁻⁹ is used to indicate signal fail (SF) and signal degrade (SD) conditions for the initiation of an automatic protection switching (APS). In addition, there is a maximum detection time requirement and an average detection time objective which depend upon the chosen BER level. For example, the maximum alarm detection time for a BER of 1×10⁻³ is 10 ms, while the average detection time objective for the BER of 1×10⁻³ is 8 ms. The algorithm used to detect alarm conditions should also be tolerant to burst errors of up to 3 ms.

Due to variations in clocks at different nodes in the network, the SONET frame may wander in time. In order to properly process the SONET signal as it passes from one node to another, each node must perform a frame synchronization, i.e. determine where the SONET frame starts. As described above, the A1 and A2 bytes indicate the start of the SONET frame for an STS-1 signal. In an STS-N signal, the bytes are interleaved and there are N A1 bytes followed by N A2 bytes. In order to synchronize the frame, each node must employ some method of determining where the A1 and A2 bytes are in the frame. In an STS-N signal where N is less than or equal to 48, the A1 bytes are all set to the value two hundred forty-six (11110110), also known in hexadecimal notation as “F6”, and the A2 bytes are all set to a value of forty (00101000), also known in hexadecimal notation as “28”. Where N is 192 or 768, enhanced framing patterns are used. These include inverse A1 and A2 bytes which are nine (00001001), hexadecimal “09”, and two hundred fifteen (11010111), hexadecimal “D7”, respectively. Where N is 768, sixty-four bytes are used for framing and the rest are scrambled.

Nodes in the network must detect the framing pattern in order to synchronize the frame and must continue to monitor the signal to detect when the frame falls out of synchronization. An out of frame (OOF) alarm occurs when the incoming signal has four consecutive errored framing patterns. Recovery from the alarm occurs when the incoming signal has two consecutive frames with no framing errors. The maximum permitted OOF detection time is 625 microseconds. Moreover, whatever framing algorithm is used, it must not declare OOF more than once every six minutes in the presence of a BER of 1×10⁻³. A loss of frame (LOF) alarm occurs when an OOF alarm persists for three milliseconds. Recovery from LOF occurs when the OOF alarm is off for one millisecond.

A popular prior art framing algorithm locates a subset of the A1 and A2 bytes that are clustered around the last A1 byte and the first A2 byte (the “A1A2 boundary”) in order to synchronize the frame. This algorithm is adequate. However, it is subject to deception by framing pattern mimics on H1H2 bytes when there is a lack of pointer movements. Deception by framing pattern mimics can be eliminated by widening the framing byte comparison to include more bytes. However, doing so leads to unnecessarily long frame synchronization time in the presence of a high BER of 1×10⁻³.

### SUMMARY OF THE INVENTION

It is therefore an object of the invention to provide a method for synchronizing a SONET/SDH frame.

It is another object of the invention to provide a method for synchronizing a SONET/SDH frame which operates quickly.

It is a further object of the invention to provide a method for synchronizing a SONET/SDH frame which operates quickly in the presence of a high BER of 1×10⁻³.

It is also an object of the invention to provide a method for synchronizing a SONET/SDH frame which is not deceived by framing pattern mimics.

In accord with these objects, which will be discussed in detail below, the frame synchronization method of the present invention uses one framing pattern comparison to find the frame and a second framing pattern comparison to monitor the frame after it is acquired. The first framing pattern comparison looks for three bytes: the first AND last of either the A1 or the A2 bytes, and the first OR last of the other of the A2 or A1 bytes. This results in four possible framing patterns, each of which is equally optimal. They are: first and last A1 plus first A2, first and last A1 plus last A2, first and last A2 plus first A1, and first and last A2 plus last A1. The first framing pattern comparison is thus twenty-four bits in length. After acquisition (i.e., after in-frame is established), the second framing pattern comparison uses only twelve bits, i.e. the last four bits of the last A1 byte and all of the first A2 byte. The first framing pattern comparisons are made with a window of N+1 bytes. The method of the invention meets the requirements of Telcordia GR-253 and eliminates aliasing in the last H2 bytes. The method can also be applied to enhanced framing in STS-192 and STS-768.

An exemplary implementation of the method is realized in a state machine. The incoming data is simultaneously shifted into multiple parallel shift registers, each having a one bit phase difference from the next. Each shift register is coupled to a frame detector which looks for the A1 and A2 bytes in the register in order to find the beginning of the frame. The outputs of the shift registers are coupled to a multiplexer and the output of the multiplexer is selected based on which frame detector finds the framing pattern. The bytes exiting the shift register in which the framing pattern is found are selected and comprise the framed signal.

Additional objects and advantages of the invention will become apparent to those skilled in the art upon reference to the detailed description taken in conjunction with the provided figures.

### BRIEF DESCRIPTION OF THE DRAWINGS

FIG. 1 is a prior art illustration of a SONET frame;

FIG. 2 is a prior art illustration of the transport and path overhead bytes in a SONET frame;

FIG. 3 is a table illustrating the first framing pattern according to the invention;

FIG. 4 is a schematic diagram of a state machine implementation of the method of the invention;

FIG. 5 is a high level schematic diagram an STS-12 framer according to the invention; and

FIG. 6 is a high level schematic diagram of an STS-48 framer according to the invention.

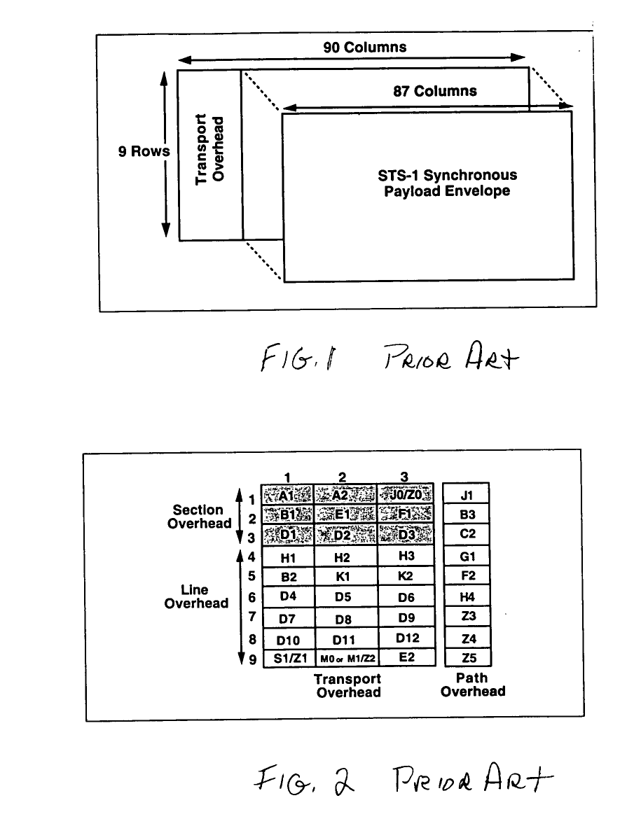

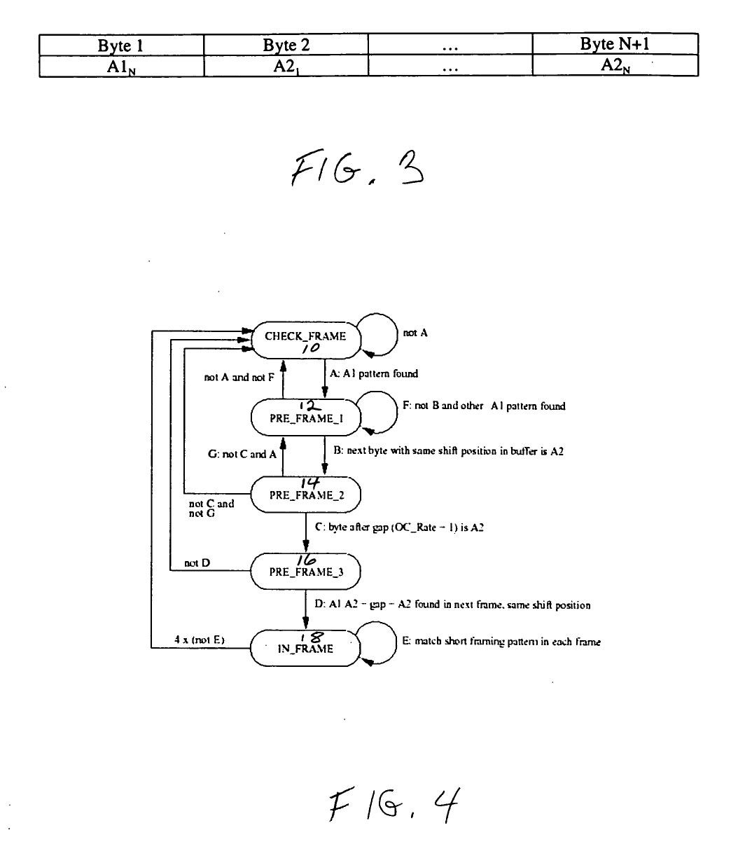

### DETAILED DESCRIPTION OF THE PREFERRED EMBODIMENTS

The frame synchronization method of the present invention uses one framing pattern comparison to find the frame and a second framing pattern comparison to monitor the frame after it is acquired. The first framing pattern comparison looks for one of the first AND last of either the A1 or the A2 bytes, and the first OR last of the other of the A2 or A1 bytes. In the illustrated embodiment of FIG. 3, the first and last A2 bytes as well as a the last A1 byte are used as the first framing pattern. The first framing pattern comparison is thus twenty-four bits.

After acquisition, the second framing pattern comparison uses only twelve bits, i.e. the last four bits of the last A1 byte and all of the first A2 byte. The framing pattern comparisons are made with a window of N+1 bytes as illustrated in FIG. 3. The method of the invention meets the requirements of Telcordia GR-253 and eliminates aliasing in the last H2 bytes. The method can also be applied to enhanced framing in STS-192 and STS-768.

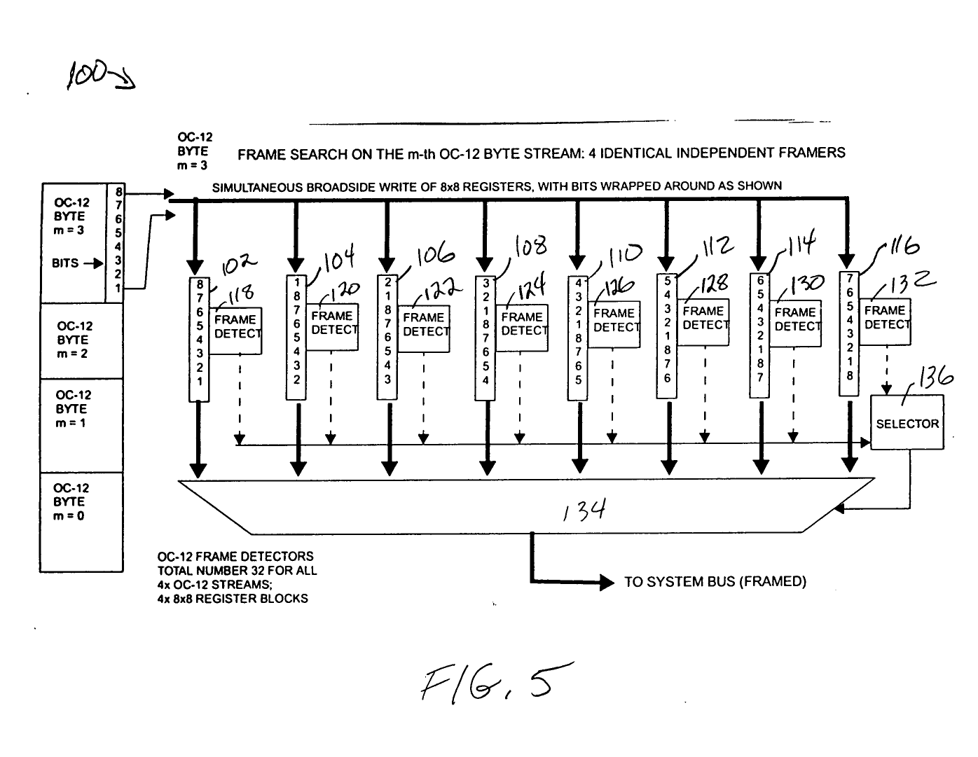

An exemplary implementation of the method is realized in a state machine which is illustrated in FIG. 4. The incoming data is shifted into a shift register. The framer looks for the A1 and A2 bytes in the register in order to find the beginning of the frame. According to an embodiment of the invention, for an STS-N signal, after determining the presence of the last A1 byte and the first A2 byte, the framer looks for the presence of last A2 byte at a location N−1 bytes from the detected first A2 byte. Thus, a window of N+1 bytes is considered.

Referring now to FIG. 4, in the CHECK_FRAME state 10, the shift register is examined to determine the presence of an A1 pattern. When an A1 pattern is found, the machine enters the PRE₁FRAME_1 state 12. There, the shift register is examined to determine whether the next byte with the same shift position in the buffer is an A2 or an A1 byte. If it is determined that the byte is neither an A2 nor an A1, the state reverts to CHECK_FRAME. If, during the PRE_FRAME_1 state 12, it is determined that the next byte with the same shift position is an A1 byte, the machine remains in the PRE_FRAME_1 state 12. If it is determined that the next byte is an A2 byte, the machine enters the PRE_FRAME_2 state 14. At the PRE_FRAME_2 state, the shift register is examined after a gap of N−1 bytes to determine whether the last A2 is present. If the last A2 is not found, but an A1 pattern is found, the machine reverts to the PRE_FRAME_1 state 12. If neither an A1 nor an A2 is found, the machine reverts to the CHECK_FRAME state 10. If the last A2 is found, the machine enters the PRE_FRAME_3 state 16. There, after a gap of exactly one frame, it is determined whether the last A2 is found in the next frame at the same shift position as previously detected. If it is not, the machine reverts to the CHECK_FRAME state 10. If it is, the machine enters the IN_FRAME state 18. While in this state, the previously described short framing pattern (12-bits) is monitored in each frame. If the short framing pattern fails to match four times, the machine reverts to the CHECK_FRAME state 10.

FIG. 5 shows an example of an STS-12 framer according to the invention. The framer 100 includes eight one byte shift registers 102, 104, 106, 108, 110, 112, 114, 116. Each register is coupled to a frame detector 118, 120, 122, 124, 126, 128, 130, 132. The outputs of the registers are coupled to data inputs of a multiplexer 134 and the outputs of the frame detectors are coupled to a selector circuit 136. The output of the selector circuit is coupled to the select input of the multiplexer. Data is simultaneously shifted into each register one bit out of phase to the next register. Each frame detector examines the contents of its respective register and applies the algorithm described above. When one of the framers detects the complete framing pattern, it signals the selector 136 which signals the multiplexer 134 to select the corresponding register for its input. The output of the multiplexer 134 comprises the framed signal.

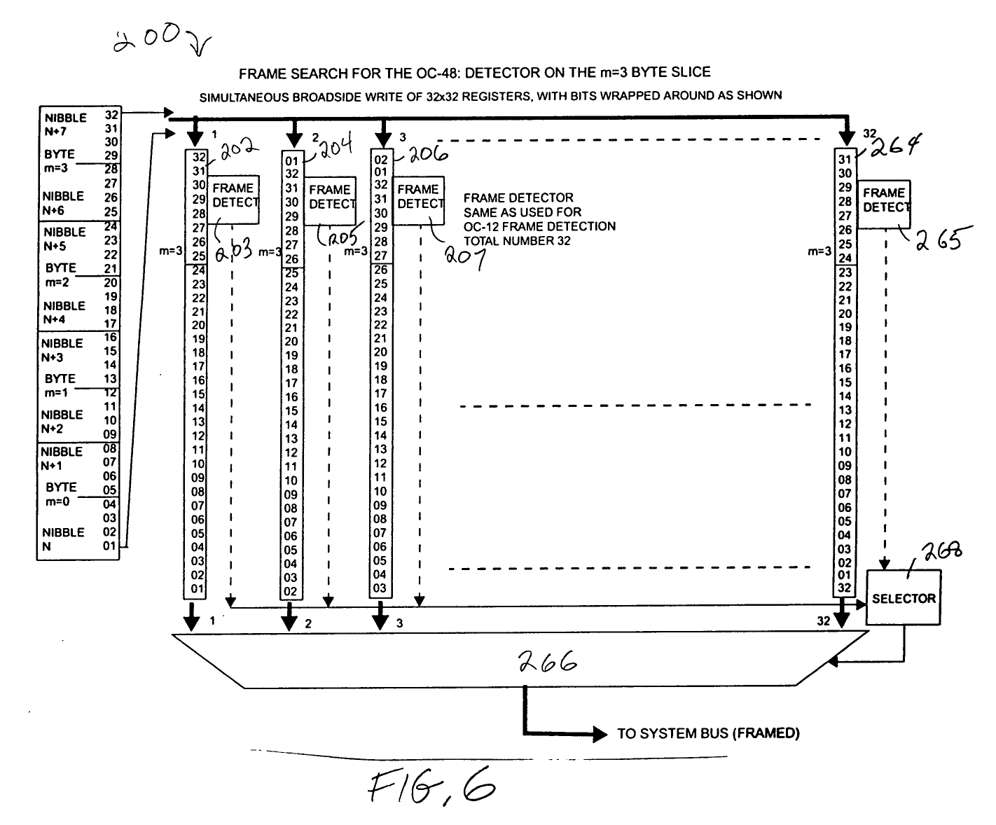

FIG. 6 shows an example of an STS-48 framer 200 which is similar to the framer of FIG. 5. The framer 200 has thirty-two shift registers 202-264, each being a thirty-two bit register. A separate framer 203-265 is coupled to each register. The output of each register is coupled to a data input of a multiplexer 266 and the output of the each framer is coupled to selector circuitry 268. The output of the selector circuitry is coupled to the select input of the multiplexer. The framer 200 operates in much the same manner as the framer 100 except that bytes are examined four at a time rather than individually.

There have been described and illustrated herein methods and apparatus for achieving and maintaining SONET/SDH frame synchronization in the presence of a specified bit error rate. While particular embodiments of the invention have been described, it is not intended that the invention be limited thereto, as it is intended that the invention be as broad in scope as the art will allow and that the specification be read likewise. Thus, while a state machine has been disclosed as an apparatus for realizing the methods, it will be appreciated that other apparatus such as a gate array could be used as well. In addition, while the methods have been disclosed using the last A1 byte plus the first and last A2 bytes, any of the four combinations described above will yield substantially the same results. Those skilled in the art will appreciate that the window of N+1 bytes applies only to framing patterns which include the last A1 and first A2 bytes. The other two framing patterns will require a window of 2N bytes. It will therefore be appreciated by those skilled in the art that yet other modifications could be made to the provided invention without deviating from its spirit and scope as claimed.

What is claimed is:

1. A method for frame synchronization of an STS-N (Synchronous Transport Signal—N) having N A1 bytes, including a first A1 byte and a last A1 byte, and N A2 bytes, including a first A2 byte and a last A2 byte, where N is an integer greater than or equal to 3, comprising:
determining the presence of a framing pattern selected from the group consisting of the first and last A1 bytes plus the first A2 byte, the first and last A1 bytes plus the last A2 byte, the first and last A2 bytes plus the first A1 byte, and the first and last A2 bytes plus the last A1 byte, and
framing the signal based on this determination.

2. The method according to claim 1, wherein:
the framing pattern is the first and last A2 bytes plus the last A1 byte.

3. The method according to claim 1, wherein:
said step of determining is accomplished by monitoring N+1 bytes of the signal.

4. The method according to claim 1, wherein:
said step of determining is accomplished by monitoring 2N bytes of the signal.

5. The method according to claim 1, further comprising:
determining the presence of the last A2 byte in the next frame, and
framing the signal only after both determinations have been made.

6. The method according to claim 1, further comprising:
monitoring a portion of the last A1 byte and all of the first A2 byte in every subsequent frame, and
restarting frame synchronization if the portion of the last A1 byte and all of the first A2 byte are not found.

7. An apparatus for frame synchronization of an STS-N (Synchronous Transport Signal—N) having N A1 bytes, including a first A1 byte and a last A1 byte, and N A2 bytes, including a first A2 byte and a last A2 byte, where N is an integer greater than or equal to 3, comprising:
a plurality of shift registers having the same bit depth, the number of shift registers being equal to the bit depth, each shift register having an input and an output, each shift register having a phase offset of one bit relative to a next shift register;
a plurality of frame detectors, one coupled to each shift register, each phase detector having an output;
a multiplexer having a plurality of data inputs, a select input, and an output, the output of each shift register being coupled to a data input of the multiplexer; and
selector circuitry having an input coupled to the outputs of the frame detectors and an output coupled to the select input of the multiplexer, wherein each frame detector detects a framing pattern having twenty-four bits and signals the selector circuitry when the framing pattern has been detected, and
the twenty-four bits are selected form the group consisting of the first and last A1 bytes plus the first A2 byte, the first and last A1 bytes plus the last A2 byte, the first and last A2 bytes plus first A1 byte, and the first and last A2 bytes plus last A1 byte.

8. The apparatus according to claim 7, wherein:
the selector circuitry signals the multiplexer to select the register associated with the frame detector that signaled frame detection.

9. The apparatus according to claim 8, wherein:
the twenty-four bits are the first and last A2 bytes plus last A1 byte.
